(19) United States
(12) Patent Application Publication
(10) Pub. No.: US 2010/0051314 A1
(43) Pub. Date: Mar. 4, 2010

(54) SHIELD CONDUCTOR AND SHIELD CONDUCTOR MANUFACTURING METHOD

(75) Inventors: Kunihiko Watanabe, Yokkaichi-shi (JP); Kazuyuki Nakagaki, Yokkaichi-shi (JP); Fujio Sonoda, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 12/312,612

(22) PCT Filed: Dec. 4, 2007
(86) PCT No.: PCT/JP2007/073406

§ 371 Date: May 19, 2009

(30) Foreign Application Priority Data
Dec. 4, 2006 (JP) 2006-327148

(51) Int. Cl. H01B 7/42; B32B 37/02

(52) U.S. Cl. 174/102 R; 156/60

(57) ABSTRACT

A shield conductor W comprises: a plurality of wires 10, a heat transfer member 30 made of synthetic resin and formed so as to tightly attach to the outer circumference of the wires and moreover collectively enwrap the wires 10, and a metal pipe 20 assembled in a manner so as to tightly attach to the outer circumference of the heat transfer member 30. The heat generated in the wires 10 is transmitted from the outer circumference of the insulating coating 12 to the heat transfer member 30, then transmitted within the heat transfer member 30, and then transmitted from the outer circumferential surface of the heat transfer member 30 to the inner circumference of the pipe 20, and is finally released to the air from the outer circumference of the pipe 20.

### TECHNICAL FIELD

The present invention relates to a shield conductor and a shield conductor manufacturing method.

### BACKGROUND ART

As a shield conductor using a non-shielded wire, collectively shielding a plurality of non-shielded wires by enwrapping with a shielding member composed of a tubular braided wire made of metal thin wires woven into meshes is known. As a protecting method for shielding members and wires in this kind of shield conductor, means for enwrapping shielding members with a protector made of synthetic resin has been generally known, however, using such protector causes a problem of increasing the number of parts.

Considering the foregoing, the applicant of the present application has suggested, as described in Patent Literature 1, a structure wherein a non-shielded wire is inserted into a metal pipe. According to this configuration, the pipe fulfills functions of shielding and protecting wires, and it is therefore advantageous because this configuration requires fewer number of parts, compared to a shield conductor using a shielding member and a protector.

[Patent literature 1]: Japanese Unexamined Patent Publication No. 2004-171952

### DISCLOSURE OF THE INVENTION

### Problem to be Solved by the Invention

In a shield conductor using a pipe, since an air layer exists between a wire and a pipe, the heat generated at the time of energizing the wire is blocked by the air of a low heat conductivity, and is hardly transmitted to the pipe. Furthermore, since there exists no venting pathway to the outside, such as a clearance between knitted stitches in a braided wire in the pipe, the heat generated in the wire is easily confined within the pipe, and the radiation performance therefore tends to degrade.

Here, a heating value at the time of applying a prescribed electrical current to the conductor is lower when a cross-section area of the conductor is larger, while a temperature rise value of the conductor caused by heat generation is more restrained when the radiation performance of the electrically-conducting path is higher. Consequently, under the environment where the upper limit of a temperature rise value of the conductor is decided, and in a shield conductor of low radiation efficiency as mentioned above, it is necessary to restrain a heating value by enlarging the cross-section area of the conductor.

However, enlarging the cross-section area of a conductor means an increased diameter and weight of the shield conductor, and therefore requires a countermeasure.

This invention has been completed based on the above circumstances, and its purpose is to improve radiation performance of a shield conductor.

### Means for Solving the Problem

As means for achieving the above-mentioned objects, a shield conductor according to the present invention comprises: a plurality of wires, a heat transfer member made of synthetic resin and formed so as to tightly attach to the outer circumference of the wires, and at the same time, collectively enwrap the outer circumference of the wires, and a metal pipe assembled in a manner so as to tightly attach to the outer circumference of the heat transfer member.

In addition, the present invention relates to a shield conductor manufacturing method which executes: a process for forming a heat transfer member, which is made of synthetic resin and tightly attaches to the outer circumference of a plurality of wires, and at the same time, collectively enwraps the plurality of wires, and a process for assembling a metal pipe in such a manner that the pipe tightly attaches to the outer circumference of the heat transfer member.

According to the present invention, since a heat transfer member made of synthetic resin intervenes in a clearance between wires and the pipe, the heat generated in the wires is transmitted to the pipe from the heat transfer member, and then discharged from the outer circumference of the pipe to the air. When compared with a configuration in which an air layer exits between the wires and the pipe without using a heat transfer member, radiation performance of the present invention is superior.

In addition, since a plurality of wires are enwrapped by a heat transfer member, the pipe's shape-following property to the outer circumference of the heat transfer member is improved by simplifying the outer circumferential shape of the heat transfer member, and eventually, the adhesion between the heat transfer member and the pipe is enhanced, thereby improving the radiation efficiency.

The following configurations are preferred as the embodiment of the present invention. The pipe may be constituted by cylindrically combining a pair of half-split bodies.

According to the above configuration, since the pipe is constituted from a pair of half-split bodies, the assembly of the pipe to the heat transfer member is easier than a configuration in which the heat transfer member is inserted into a pipe that is cylindrically formed.

The pair of half-split bodies may have ears protruding outwardly along the side fringes corresponding to each other when the half-split bodies are combined, and the ears of the pair of half-split bodies may be formed in a manner so as to be spaced-apart when the half-split body is individually and externally fitted to the heat transfer member. The ears, that are spaced-apart when the pair of half-split bodies is externally fitted to the heat transfer member, may be brought closer to each other and conductibly combined, and thereby constituting the pipe.

According to the above configuration, the ears, that are spaced-apart when the pair of half-split bodies is externally fitted to the heat transfer member, are brought closer to each other and combined, so that the inner circumferential surface of the half-split bodies, in short, the pipe is surely and tightly attached to the outer circumferential surface of the heat transfer member. This improves heat transfer efficiency from the outer circumference of the heat transfer member to the inner circumference of the pipe.

The corresponding ears may be rigidly fixed to each other by seam welding.

When spot welding is used as means for combining the ears to each other, the formation region of the magnetic closed circuit is limited to the welded part, however, in the present invention, the ears are combined to each other by seam welding, and thus, the magnetic closed circuit is formed across the entire length of the pipe, thereby delivering a high shielding performance.

A shield conductor manufacturing method may execute: a process for forming an ear, which protrudes outwardly along the side fringe of a pair of half-split bodies, in a corresponding position at the time when the pair of half-split bodies is combined, a process for externally and individually fitting the pair of half-split bodies to the heat transfer member, and a process for constituting the pipe by bringing the ears closer to each other and rigidly and conductibly fixing them so that the pair of half-split bodies is combined and at the same time tightly attached to the heat transfer member.

Since the pipe is constituted from a pair of half-split bodies, the assembly of the pipe to the heat transfer member is easier than a configuration in which the heat transfer member is inserted into a pipe that is cylindrically formed.

Additionally, since the ears, that are spaced-apart when the pair of half-split bodies are externally fitted to the heat transfer member, are brought closer to each other and rigidly fixed, the inner circumferential surface of the half-split bodies, in short, the pipe is surely and tightly attached to the outer circumferential surface of the heat transfer member. This improves heat transfer efficiency from the outer circumference of the heat transfer member to the inner circumference of the pipe.

### Advantageous Effect

According to the present invention, radiation performance in a shield conductor can be improved.

### BRIEF DESCRIPTION OF THE DRAWINGS

FIG. 1 is a cross-sectional view showing a shield conductor according to Embodiment 1;

FIG. 2 is a cross-sectional view showing a forming method of a heat transfer member;

FIG. 3 is an exploded perspective view showing a shield conductor;

FIG. 4 is a cross-sectional view showing a shield conductor in the middle of being manufactured;

FIG. 5 is a graph showing radiation performance.

### DESCRIPTION OF SYMBOLS

W . . . Shield conductor

10 . . . Wire

20 . . . Pipe

21 . . . Half-split body

24 . . . Ear

30 . . . Heat transfer member

### BEST MODE FOR CARRYING OUT THE INVENTION

### Embodiment 1

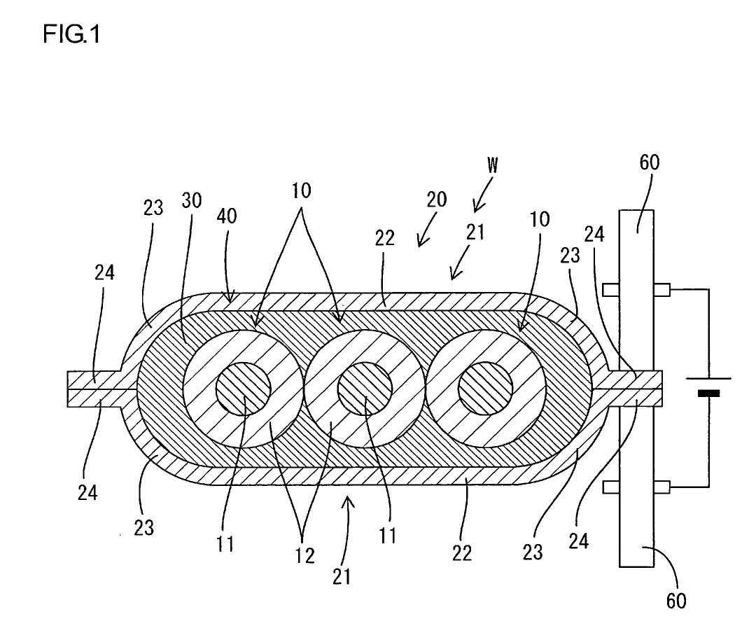

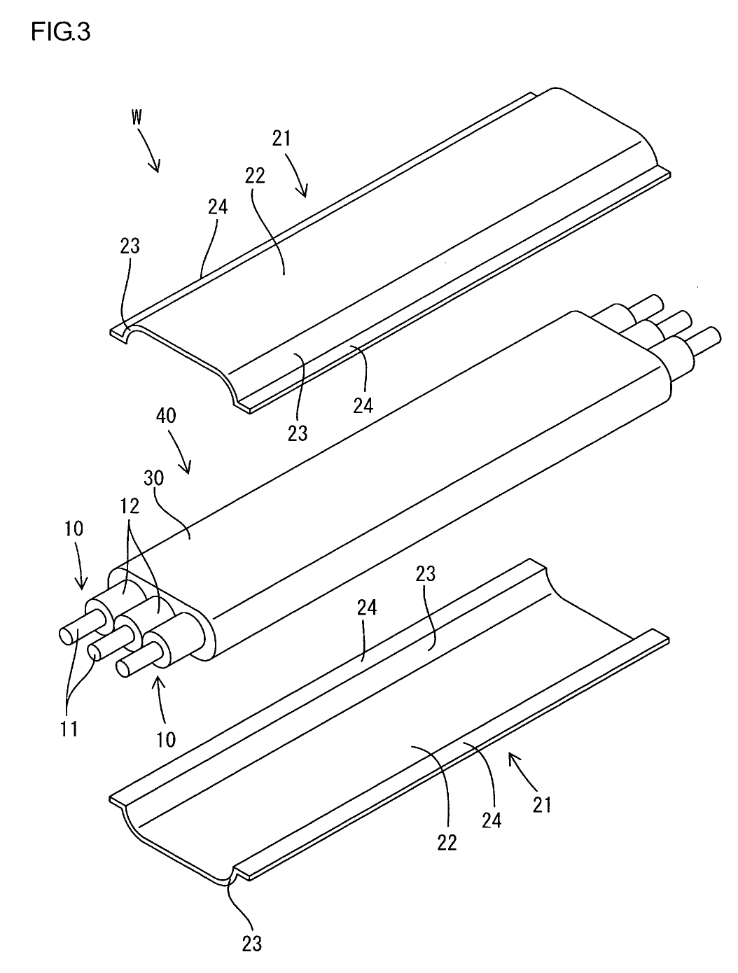

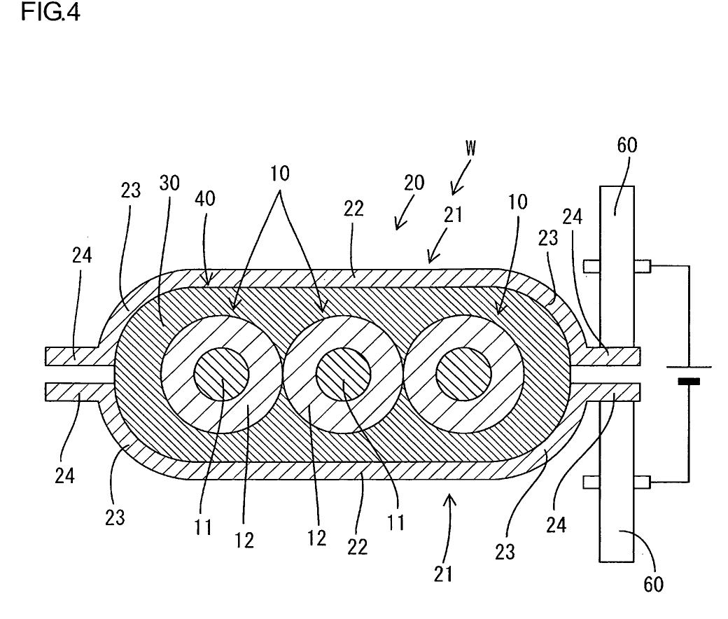

In what follows, as referring now to FIGS. 1 to 4, Embodiment 1 which materializes the present invention is described. A shield conductor W according to the present embodiment is placed, for example, between devices such as a battery, an inverter, and a motor (not shown) that compose a drive power source in an electric vehicle, and constituted in a manner that three wires 10 of non-shielded type are inserted into a pipe 20 which has both functions of collective shielding and protecting wire, with a heat transfer member 30 intervened in a clearance between the outer circumference of the wires 10 and the inner circumference of the pipe 20.

The wire 10 is formed by enwrapping the outer circumference of a metal conductor 11 (the metal is, for example, aluminum alloy and copper alloy) with an insulating coating 12 made of synthetic resin, and the conductor 11 is made of a single core wire or a twisted wire spirally twisting a plurality of thin wires (not shown). The cross-sectional shape of the conductor 11 and the insulating coating 12 are a perfect circular shape in that of the wire 10.

The pipe 20 is metallic (for example, aluminum alloy and copper alloy), having higher heat conductivity than air. The cross-sectional shape of the pipe 20 is oval and long in the right and the left direction, being different from that of the wire 10. Three wires 10 are inserted into the pipe 20, while both ends of the wire 10 are held in a state of being guided to the outside of the pipe 20. Three wires 10 inside the pipe 20 are arranged so as to align horizontally, and the outer circumference of the insulating coatings 12 of the adjacent wires 10 are in a line contact manner.

The pipe 20 is configured by cylindrically combining a pair of upper and lower, press-molded half-split bodies 21. In other words, a pair of the half-split bodies 21 is combined in a direction perpendicular to the aligning direction of the three wires 10. A pair of the half-split bodies 21 has an identical shape, and is positioned in the up-down reverse direction from each other. Each half-split body 21 is composed of a horizontal flat plate part 22 and a pair of curved plate parts 23 that are smoothly extending in a quarter circular shape from both the right and left side fringes of the flat plate part 22. Formed in the both side fringes of the curved plate parts 23, that vertically correspond to each other when a pair of the half-split bodies 21 is combined, are a pair of ears 24 extending along the side fringes. Ears 24 are shaped so as to protrude outwardly in a flat plate manner from the outer surface of the half-split body 21 in the width direction (horizontal direction), in other words, in the orthogonal direction from the side fringes of the curved plate part 23, and continuously formed across the whole length of the half-split body 21 at a constant width.

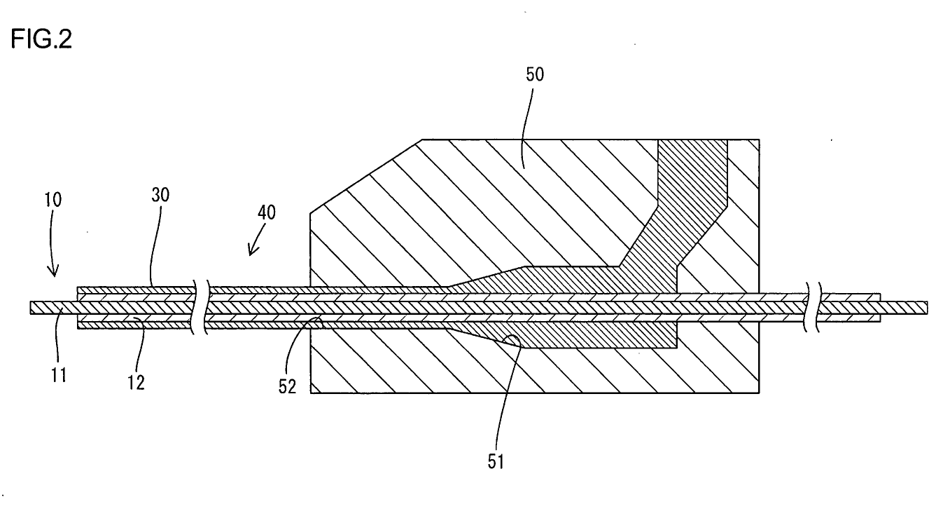

The heat transfer member 30 is made of synthetic resin, and formed so as to tightly attach to the outer circumference of the three wires 10 arranged in a horizontal line, and collectively enwrap those three wires 10. When performing molding, as shown in FIG. 2, the three wires 10 arranged in a horizontal line penetrate through a cavity 51 in a molding machine 50 from the rear side, while at the same time, the molten resin supplied into the cavity 51 is adhered to the outer circumference of the three wires 10 so as to be discharged along with the three wires 10 from an outlet port 52, which forms the oval shape of the front end of the cavity 51. This allows the heat transfer member 30 to be molded, and at the same time, allows the three wires 10 to be held by the heat transfer member 30 in positions in a horizontal line, and thereby manufacturing a collective conductor 40 which integrates the heat transfer member 30 and the three wires 10. The outer circumferential shape (a shape viewed in the axial direction of the wires 10) of the heat transfer member 30 (collective conductor 40) is oval. In addition, the thickness of the heat transfer member 30 is slightly larger than that of the vertical thickness between the inner surfaces of the flat plate parts 22 at the time when a pair of the half-split bodies 21 is combined. The width of the heat transfer member 30 is nearly the same as that of the area of the half-split bodies 21 excepting the ears 24, in short, the width between the side fringes of the right and left curved plate parts 23.

When manufacturing the shield conductor W, a pair of the half-split bodies 21 is externally fitted to the collective conductor 40 so as to hold the same vertically, and then the inner surface of the flat plate part 22 and the inner surface of the curved plate part 23 are tightly attached to the outer surface of the heat transfer member 30. In this state, there appears a clearance between corresponding ears 24 up and down. In this state, these spaced-apart ears 24 are held between a pair of upper and lower rollers 60 to be tightly attached to each other, while at the same time, a voltage is applied between both the rollers 60 so that seam welding is performed, and thereby combining and tightly attaching the ears 24 to each other in a surface contact manner. By conducting seam welding of the ears 24 in both the right and left side fringe parts, a pair of the half-split bodies 21 is combined and rigidly fixed, so as to form a cylindrical shape continuing across the entire circumference and having an oval cross-section, and thereby constituting the pipe 20. And at the same time, the pipe 20 and the collective conductor 40 are integrated, so as to complete the shield conductor W.

In a conventional shield conductor, since an air layer exists between a wire and a pipe, the heat generated at the time of energizing the wire is blocked by the air layer having a low heat conductivity, and is hardly transmitted to the pipe. Furthermore, since there exists no venting pathway to the outside, such as a clearance between knitted stitches in a braided wire, the heat generated in the wire is easily confined within the pipe, and the radiation performance therefore tends to degrade.

In response to this, the shield conductor W according to the present embodiment is provided with the heat transfer member 30, which is made of synthetic resin and tightly attaches to the outer circumference of the three wires 10 to collectively enwrap the same, and has a configuration in which the metal pipe 20 is mounted so as to tightly attach to the outer circumference of this heat transfer member 30, so that the heat transfer member 30 having a higher heat conductivity than air and made of synthetic resin intervenes in a clearance between the wires 10 and the pipe 20. Consequently, the heat generated in the wires 10 is transmitted to the heat transfer member 30 from the outer circumference of the insulating coating 12, then transmitted within the heat transfer member 30, and then to the inner circumference of the pipe 20 from the outer circumferential surface of the heat transfer member 30, and finally released to the air from the outer circumference of the pipe 20. As mentioned, according to the present embodiment, the heat releasing performance for the heat generated in the wire 10 is advanced, compared with the conventional art in which an air layer exists between the wire and the pipe, without the heat transfer member.

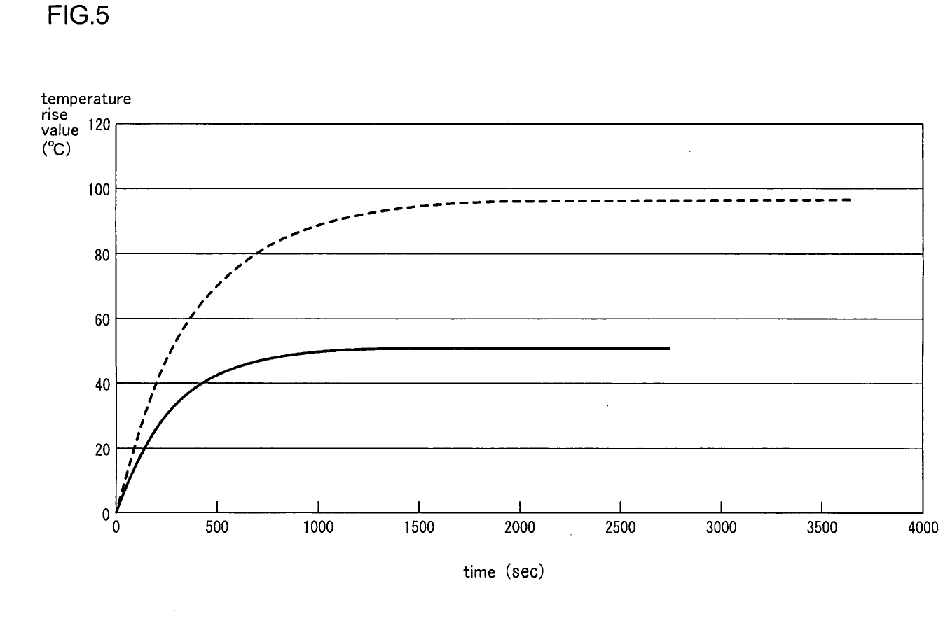

A shield conductor according to the present embodiment is superior in radiation efficiency as mentioned above, and FIG. 5 shows a graph of the experimental result comparing the radiation performances of the shield conductor according to the present embodiment and the conventional shield conductor, constituted in a manner that a circular-shaped pipe collectively enwraps and bundles three wires so that respective center of axis of the wires form a triangle, with an air layer exists between the wires and the pipe.

The pipe 20 according to the present embodiment is made of stainless steel, wherein the major diameter of the outer circumference is 18.5 mm (the size in the horizontal direction in FIG. 1), the minor diameter of the outer circumference is 10.5 mm (the size in the vertical direction in FIG. 1), and the plate thickness is 1.0 mm. On the other hand, the conventional pipe is also made of stainless steel, and the internal diameter thereof is 13.0 mm, while the external diameter thereof is 15.0 mm. The wire is common between the conventional shield conductor and the shield conductor according to the present embodiment, wherein the conductor of the wire is made from aluminum alloy, the diameter of the conductor is 3.2 mm, and the external diameter of the insulating coating is 4.8 mm. An electrical current at 60 A is continuously applied to the wire until the temperature of the conductor becomes saturated (for 2800 to 3800 sec), and then the temperature rise of the conductor relative to the surrounding temperature was measured. The temperature measuring point is the boundary surface between the outer circumference of the conductor and the inner circumference of the insulating coating in the wire. And also, regarding both the conventional shield conductor and the shield conductor according to the present embodiment, wind at 3.1 to 3.3 m/sec is applied to the pipe in order to air-cool (to cool with an air current).

Firstly, in the conventional shield conductor without the heat transfer member 30, as indicated with a dashed line in FIG. 5, the temperature rise continued even after about 1500 sec of energizing, and the temperature rise value in a saturated state was about 97 degrees C. In this respect, in the shield conductor according to the present embodiment comprising the heat transfer member 30, as indicated with a solid line in FIG. 5, the temperature generally reaches a saturated state after about 1000 sec, and the temperature rise value at this moment is restrained to about 51 degrees C. In addition, while energizing, the shield conductor according to the present invention keeps a constant state of lower temperature rise value compared with the conventional shield conductor, and in this respect, it can be understood that the shield conductor according to the present embodiment is superior to the conventional shield conductor in radiation performance not only in a saturated state but also in a period of time until reaching a saturated state.

As an effect of improvement in radiation performance, weight reduction of the shield conductor W can be expected. In short, when a prescribed electrical current is applied to the wire 10 (the conductor 11), the smaller the cross-section area of the conductor 11 is, the greater the heating value of the wire 10 increases. However, according to the present embodiment which is superior in radiation performance, the temperature rise of the wire 10 can be restrained even when the heating value of the wire 10 is large. Therefore, under the environment where the upper limit of temperature rise of the wire 10 is determined like an electric vehicle, replacing the conventional shield conductor with the shield conductor W in the present embodiment that is superior in radiation performance enables the tolerance of heat generation of the wire 10 to increase relatively. And then, a relatively increased tolerance of heat generation of the wire 10 means it is possible to shrink the minimum and possible cross-section area of the conductor 11 under the environment where the upper limit of the temperature rise value of the wire 10 is determined, and the shield conductor W can therefore be more lightweight and downsized by shrinking the cross-section area of the conductor 11.

Additionally, in the present embodiment, three wires 10 are collectively enwrapped by the heat transfer member 30 so that the outer circumferential shape of the heat transfer member 30 is simplified to an oval shape of less unevenness, and thereby improving the shape-following property of the pipe 20 to the outer circumference of the heat transfer member 30. Furthermore, this enhances the adhesion between the heat transfer member 30 and the pipe 20, achieving improved radiation efficiency.

Additionally, the pipe 20 is constituted by combining a pair of the half-split bodies 21, and thus, the assembly of the pipe 20 to the heat transfer member 30 in the present embodiment is easier, compared with a configuration in which a heat transfer member is inserted into a pipe molded in a cylindrical shape.

In addition, the corresponding ears 24 are constituted so as to be spaced apart when a pair of the half-split bodies 21 is independently and externally fitted to the heat transfer member 30, and thus, the pipe 20 is constituted by bringing such spaced-apart ears 24 closer to each other and rigidly and conductibly fixing them. As the spaced-apart ears 24 are being rigidly fixed each other, a pair of the half-split bodies 21 approaches, while at the same time, the inner circumferential surfaces of a pair of the half-split bodies 21 are pressed tightly to the outer circumferential surface of the collective conductor 40 (heat transfer member 30), so that the inner circumferential surface of the half-split bodies 21, in short, the pipe 20 is surely and tightly attached to the outer circumferential surface of the heat transfer member 30. This improves the heat transfer efficiency from the outer circumference of the heat transfer member 30 to the inner circumference of the pipe 20.

Also, when spot welding is used as a means to combine the spaced-apart ears 24 to each other, the formation region of the magnetic closed circuit is limited to the welded part. However, according to the present embodiment, the ears 24 are conductibly fixed each other by seam welding, so that the magnetic closed circuit is formed across the entire length of the pipe 20. This achieves a high shielding performance.

### Other embodiments

With embodiments of the present invention described above with reference to the accompanying drawings, it is to be understood that the invention is not limited to those precise embodiments, and the embodiments below, for example, can be within the scope of the present invention.

(1) The pipe may be a single part cylindrically molded in accordance with the outer circumferential shape of the heat transfer member. In this case, the heat transfer member may be inserted into the pipe, and in this state, the pipe may be subjected to press molding for plastic deformation, so as to tightly attach to the outer circumference of the heat transfer member.

(2) With a pair of half-split bodies externally and individually fitted to the heat transfer member, the corresponding ears may abut or tightly attach to each other

(3) As means for combining the ears each other, such as a method of spot welding, a method for combining the side fringes in the half-split bodies by soldering, and a method for combining the ears so as to hold them with combining parts other than the pipe may be employed

(4) The cross-sectional shapes of the heat transfer member and the pipe may be other than oval, such as an ellipse shape and a perfect circular shape

(5) The arrangement of three wires may be in a manner so that the center of axles of these wires form an equilateral triangle

(6) The number of wires to be enwrapped by one heat transfer member may be two or four or more

(7) In the above embodiment, the adjacent wires contact each other inside the heat transfer member, however, the adjacent wires may be arranged so as not to contact each other inside the heat transfer member

(8) In the above embodiment, a pair of the half-split bodies are combined in a direction perpendicular to the arranging direction of the wires, however, the present invention is not limited to this, and a pair of the half-split bodies may be combined in a direction parallel to the arranging direction of the wires

(9) A pair of the half-split bodies may be formed in shapes different each other

(10) The pipe may be constituted by combining three or more parts

(11) The cross-sections of the conductor 11 and the insulating coating 12 may be other than a perfect circular shape, such as an ellipse shape, an oval shape, and a rectangular shape.

1.-7. (canceled)

8. A shield conductor comprising:
a plurality of wires,
a heat transfer member made of synthetic resin and molded so as to tightly attach to the outer circumference of the wires and collectively enwrap the outer circumference of the wires, and
a metal pipe mounted so as to tightly attach to the outer circumference of the heat transfer member.

9. The shield conductor according to claim 8, wherein the pipe is constituted by cylindrically combining a pair of half-split bodies.

10. The shield conductor according to claim 9, wherein
an ear is formed in the pair of half-split bodies, so as to outwardly protrude along side fringes, and that correspond to each other when the pair of half-split bodies is combined,
the corresponding ears in the pair of half-split bodies are formed in a manner so as to be spaced-apart when the half-split body is individually and externally fitted to the heat transfer member, and
the ears are brought closer to each other and combined conductibly, and thereby constitute the pipe.

11. The shield conductor according to claim 10, wherein the ears are rigidly fixed by seam welding.

12. A shield conductor manufacturing method which executes:
a process for forming a heat transfer member, which is made of synthetic resin and tightly attaches to the outer circumference of a plurality of wires and moreover collectively enwraps the plurality of wires, and
a process for assembling a metal pipe in such a manner that the pipe tightly attaches to the outer circumference of the heat transfer member.

13. The shield conductor manufacturing method according to claim 12, which executes:
a process for forming an ear, which is protruding outwardly along side fringe of a pair of half-split bodies, in a corresponding position at the time when the pair of half-split bodies is combined,
a process for externally and individually fitting the pair of half-split bodies to the heat transfer member, and
a process for constituting the pipe by bringing the ears closer to each other and rigidly and conductibly fixing the ears so that the pair of half-split bodies is combined, and at the same time, tightly attached to the heat transfer member.

14. The shield conductor manufacturing method according to claim 13, which executes a process for rigidly fixing the corresponding ears to each other by seam welding.
